(19) United States
(12) Patent Application Publication
(10) Pub. No.: US 2025/0135950 A1
(43) Pub. Date: May 1, 2025

(54) POWER STORAGE SYSTEM

(71) Applicant: HONDA MOTOR CO., LTD., Tokyo (JP)

(72) Inventors: Yasushi OGIHARA, Saitama (JP); Satoshi Hashino, Tokyo (JP); Yasuo Yamada, Saitama (JP)

(73) Assignee: HONDA MOTOR CO., LTD., Tokyo (JP)

(21) Appl. No.: 18/923,705

(22) Filed: Oct. 23, 2024

(30) Foreign Application Priority Data
Oct. 25, 2023 (JP) 2023-183270

(51) Int. Cl. B60L 58/19; B60L 1/00; B60L 15/00; B60L 50/60; B60L 53/24; H01M 10/42

(52) U.S. Cl. CPC B60L 58/19; B60L 1/00; B60L 15/007; B60L 50/60; B60L 53/24; H01M 10/4264; H01M 2220/20

(57) ABSTRACT

A power storage system includes: a battery including a first power storage, a second power storage, and a first switch unit; a three-phase motor in which coils of three phases are connected at a neutral point, the three-phase motor being driven by electric power supplied from the battery; an inverter connected on an electric power transmission path between the battery and the three-phase motor; a DC power supply circuit connected to a first connection portion positioned on an electric power transmission path between the inverter and the battery; a capacitor provided on the electric power transmission path between the battery and the three-phase motor; and a branch circuit that branches off from the DC power supply circuit on a positive electrode side and is connected to a coil of any one phase among the coils of three phases. The first switch unit includes a semiconductor switch.

### CROSS-REFERENCE TO RELATED APPLICATIONS

This application is based on and claims priority under 35 USC 119 from Japanese Patent Application No. 2023-183270 filed on Oct. 25, 2023, the contents of which are incorporated herein by reference.

### TECHNICAL FIELD

The present disclosure relates to a power storage system.

### BACKGROUND

In recent years, researches and developments have been conducted on charging and electric power supply in a vehicle mounted with a secondary battery that contributes to energy efficiency in order to allow more people to have access to affordable, reliable, sustainable, and advanced energy.

Regarding charging and power supply in a vehicle including a secondary battery, there are two types of charging equipment such as charge stations which are compatible with 400 V class and 800 V class, respectively. When a vehicle is compatible with only the 400 V class charging equipment, the vehicle cannot enjoy quick charging performance of the 800 V class charging equipment by the 800 V class charging equipment.

In a case where the vehicle is both compatible with the 400 V class charging equipment and the 800 V class charging equipment, generally, a voltage is boosted to 800 V by a voltage converter when charging by the 400 V class charging equipment, or the voltage is stepped down to 400 V by the voltage converter when charging by the 800 V class charging equipment. However, using such a voltage converter for charging deteriorates efficiency during charging.

In this regard, a literature discloses a vehicle in which a connection system of a battery module is switched so as to be chargeable by both the 400 V class charging equipment and the 800 V class charging equipment without using any voltage converter for charging (for example, see Japanese Patent Application Laid-Open Publication No. 2019-080474 (hereinafter, referred to as Patent Literature 1) and Japanese Patent Application Laid-Open Publication No. 2020-150618 (hereinafter, referred to as Patent Literature 2).

By the way, there are two types of auxiliary devices used in a vehicle, one is driven at 400 V class and the other one is driven at 800 V class. In the vehicle in which the connection system of the battery module is switched, voltage conversion is generally performed by a voltage converter for auxiliary devices, for example, when a 400 V class auxiliary device is to be driven during charging by the 800 V class charging equipment, or when an 800 V class auxiliary device is to be driven during charging by the 400 V class charging equipment.

However, such a voltage converter for auxiliary devices is expensive and thus a manufacturing cost increases.

The present disclosure provides a power storage system capable of being efficiently charged according to a voltage state of charging equipment while reducing a manufacturing cost.

### SUMMARY

An aspect of the present disclosure relates to a power storage system including: a battery including a first power storage, a second power storage, and a first switch unit configured to switch between a first voltage state in which the first power storage and the second power storage are connected in series and chargeable at a first voltage, and a second voltage state in which the first power storage and the second power storage are connected in parallel and chargeable at a second voltage; a three-phase motor in which coils of three phases are connected at a neutral point, the three-phase motor being driven by electric power supplied from the battery; an inverter connected on an electric power transmission path between the battery and the three-phase motor; a DC power supply circuit connected to a first connection portion positioned on an electric power transmission path between the inverter and the battery; a capacitor provided on the electric power transmission path between the battery and the three-phase motor; and a branch circuit that branches off from the DC power supply circuit on a positive electrode side and is connected to a coil of any one phase among the coils of three phases. The first switch unit includes a semiconductor switch.

### BRIEF DESCRIPTION OF DRAWINGS

Exemplary embodiments of the present invention will be described in detail based on the following figures, wherein:

FIG. 1 is a diagram showing a configuration of a power storage system 1 according to a first embodiment;

FIG. 2 is a diagram showing a first voltage state (800 V start-up) of a battery 2;

FIG. 3 is a diagram showing a second voltage state (400 V start-up) of the battery 2;

FIG. 4 is a diagram showing a flow of a current during traveling of an electric vehicle including the power storage system 1 according to the first embodiment;

FIG. 5 is a diagram showing a flow of a current during charging at a first voltage (800 V) of the electric vehicle including the power storage system 1 according to the first embodiment;

FIG. 6 is a diagram showing a flow of a current during charging at a second voltage (400 V) of the electric vehicle including the power storage system 1 according to the first embodiment;

FIG. 7 is a diagram showing an operation sequence during traveling of the electric vehicle including the power storage system 1 according to the first embodiment;

FIG. 8 is a diagram showing an operation sequence during charging at the first voltage (800 V) of the electric vehicle including the power storage system 1 according to the first embodiment;

FIG. 9 is a diagram showing an operation sequence during charging at the second voltage (400 V) of the electric vehicle including the power storage system 1 according to the first embodiment;

FIG. 10 is a diagram showing a flow of a current during a pre-charge operation in the first voltage state (800 V start-up) of the battery 2 according to a comparative example;

FIG. 11 is a diagram showing an operation sequence during the pre-charge operation according to the comparative example;

FIG. 12 is a diagram showing a flow of a current during a pre-charge operation in the first voltage state (800 V start-up) of the battery 2 according to the first embodiment;

FIG. 13 is a diagram showing an operation sequence during the pre-charge operation according to the first embodiment;

FIG. 14 is a diagram showing a configuration of an electric vehicle including the power storage system 1 according to a second embodiment;

FIG. 15 is a diagram showing a flow of a current during traveling of the electric vehicle including the power storage system 1 according to the second embodiment;

FIG. 16 is a diagram showing a flow of a current during charging at the first voltage (800 V) of the electric vehicle including the power storage system 1 according to the second embodiment;

FIG. 17 is a diagram showing a flow of a current during charging at the second voltage (400 V) of the electric vehicle including the power storage system 1 according to the second embodiment;

FIG. 18 is a diagram showing an operation sequence during traveling of the electric vehicle including the power storage system 1 according to the second embodiment;

FIG. 19 is a diagram showing an operation sequence during charging at the first voltage (800 V) of the electric vehicle including the power storage system 1 according to the second embodiment;

FIG. 20 is a diagram showing an operation sequence during charging at the second voltage (400 V) of the electric vehicle including the power storage system 1 according to the second embodiment; and

FIG. 21 is a diagram showing a configuration of a modification of the power storage system 1 according to the first embodiment.

### DESCRIPTION OF EMBODIMENTS

Hereinafter, embodiments of the present disclosure will be described with reference to the drawings.

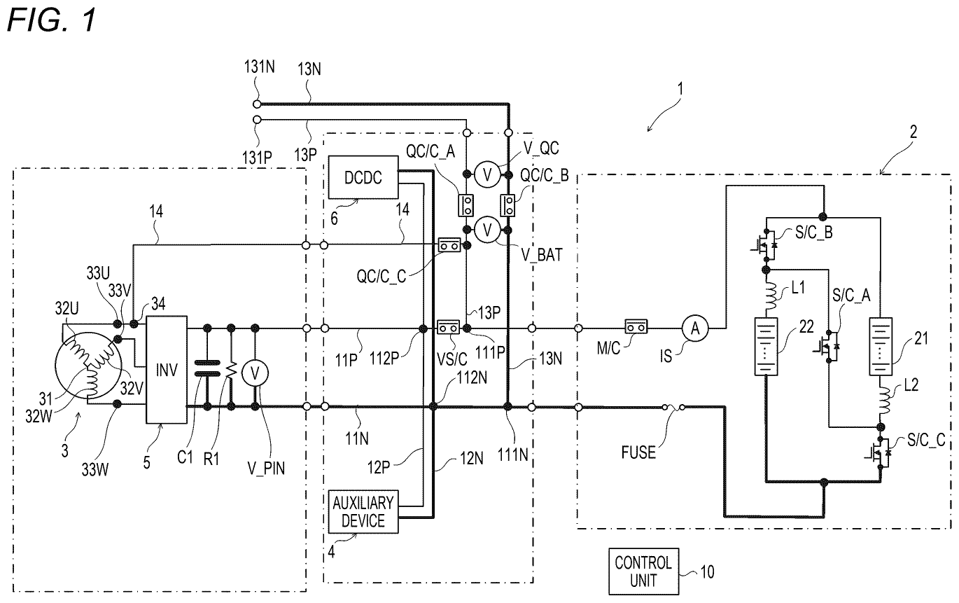

First, a first embodiment of the present disclosure will be described with reference to FIGS. 1 to 13.

### First Embodiment

A power storage system 1 according to the first embodiment shown in FIG. 1 is mounted on an electric vehicle such as an electric automobile. The electric vehicle including the power storage system 1 is compatible with charging equipment of 400 V class and 800 V class. The electric vehicle can not only quickly charge a battery 2 at charge voltages of 400 V and 800 V but also efficiently drive a three-phase motor 3 and an auxiliary device 4 at a base voltage of 800 V.

Specifically, as shown in FIG. 1, the power storage system 1 includes the battery 2, the three-phase motor 3, the auxiliary device 4, an inverter 5 (INV), a DC-DC converter 6, electric power supply circuits 11P and 11N, auxiliary device drive circuits 12P and 12N, DC power supply circuits 13P and 13N, a branch circuit 14, and a control unit 10.

As shown in FIGS. 1 to 3, the battery 2 includes a first power storage 21, a second power storage 22, a first contactor M/C, a first to third semiconductor switches S/C_A, S/C_B, S/C_C, a first and second reactors L1 and L2, a current sensor IS, and a current breaker FUSE.

The first power storage 21 and the second power storage 22 are battery modules which can perform charging and discharging of 400 V.

The first contactor M/C is provided on a positive electrode side end of the battery 2 and functions as a main switch which turns on and off connection to the outside (the electric power supply circuit 11P) of the battery 2.

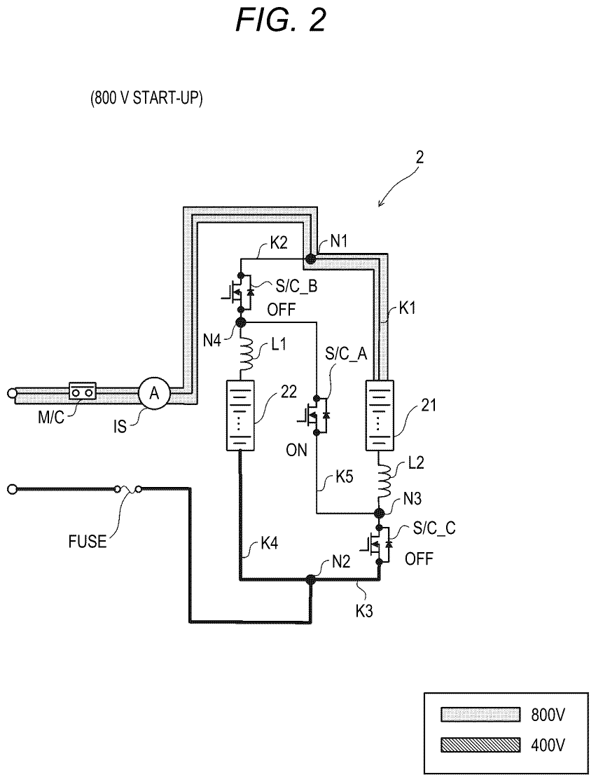

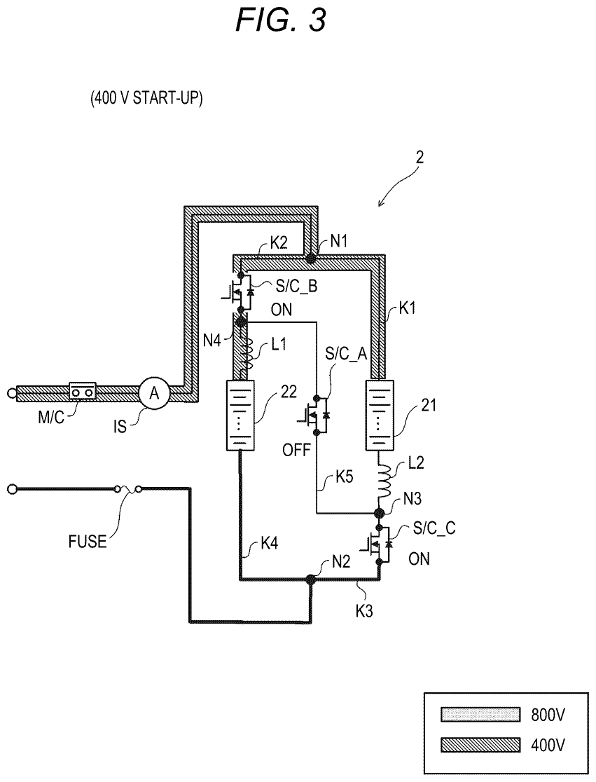

The first to third semiconductor switches S/C_A, S/C_B, S/C_C each include a MOSFET, a bipolar transistor, an IGBT and the like, and switch a connection state between the first power storage 21 and the second power storage 22. For example, as shown in FIG. 2, when the first semiconductor switch S/C_A is turned on whereas the second semiconductor switch S/C_B and the third semiconductor switch S/C_C are turned off, the battery 2 enters a first voltage state (800 V start-up) in which the first power storage 21 and the second power storage 22 are connected in series, so that the battery 2 can perform charging and discharging at 800 V. As shown in FIG. 3, when the first semiconductor switch S/C_A is turned off whereas the second semiconductor switch S/C_B and the third semiconductor switch S/C_C are turned on, the battery 2 enters a second voltage state (400 V start-up) in which the first power storage 21 and the second power storage 22 are connected in parallel, so that the battery 2 can perform charging and discharging at 400 V. Note that the term start-up refers to a concept including driving during traveling of an electric vehicle including the power storage system 1 and charging during parking of the electric vehicle. The first to third semiconductor switches S/C_A, S/C_B, and S/C_C constitute an example of a first switch unit configured to switch between the first voltage state (800 V start-up) and the second voltage state (400 V start-up).

The first and second reactors L1, L2 are arranged in series with the first to third semiconductor switches S/C_A, S/C_B, and S/C_C, and are configured to prevent short circuits when the first to third semiconductor switches S/C_A, S/C_B, and S/C_C are turned on.

More specifically, as shown in FIGS. 2 and 3, the battery 2 includes a positive electrode side node N1, a negative electrode side node N2, a negative electrode side connection node N3, and a positive electrode side connection node N4. A positive electrode side path K1 of the first power storage 21 and a positive electrode side path K2 of the second power storage 22 are connected in parallel at the positive electrode side node N1. A negative electrode side path K3 of the first power storage 21 and a negative electrode side path K4 of the second power storage 22 are connected in parallel at the negative electrode side node N2. A series connection path K5 connecting the negative electrode side path K3 of the first power storage 21 and the positive electrode side path K2 of the second power storage 22 and the negative electrode side path K3 of the first power storage 21 are connected at the negative electrode side connection node N3. The series connection path K5 and the positive electrode side path K2 of the second power storage 22 are connected at the positive electrode side connection node N4.

The first semiconductor switch S/C_A is disposed in the series connection path K5, the second semiconductor switch S/C_B is disposed between the positive electrode side node N1 and the positive electrode side connection node N4, and the third semiconductor switch S/C_C is disposed between the negative electrode side node N2 and the negative electrode side connection node N3. The first reactor L1 is disposed between the positive electrode side connection node N4 and a positive electrode of the second power storage 22, and the second reactor L2 is disposed between the negative electrode side connection node N3 and a negative electrode of the first power storage 21. In this way, when starting up at the first voltage (800 V), the two reactors L1 and L2 are connected in series, and when starting up at the second voltage (400 V), the reactor L1 and the reactor L2 are connected to the paths respectively, with the reactors L1 and L2 being appropriately positioned depending on the voltage. Note that the number and arrangement of the reactors are not limited to the above example. It is sufficient that at least one reactor is disposed in the circuit in each of the first voltage state (800 V start-up) and the second voltage state (400 V start-up), and therefore, for example, even with a single reactor disposed between the first contactor M/C and the current sensor IS, it is possible to prevent short circuits when the first to third semiconductor switches S/C_A, S/C_B, and S/C_C are turned on.

With such a battery 2, the first to third semiconductor switches S/C_A, S/C_B, and S/C_C are used to switch between the first voltage state (800 V start-up) and the second voltage state (400 V start-up), and therefore, by performing pulse width modulation (PWM) control on the first to third semiconductor switches S/C_A, S/C_B, and S/C_C, it becomes possible to pre-charge a first smoothing capacitor C1, which will be described later. Accordingly, as compared with a case where switching between the first voltage state (800 V start-up) and the second voltage state (400 V start-up) using a mechanical switch (such as a contactor) which is not capable of high frequency switching, a pre-charge circuit is no longer required, thus reducing the volume and weight of the circuits for the battery 2. Note that the PWM control on the first to third semiconductor switches S/C_A, S/C_B, and S/C_C will be described later.

The current sensor IS is disposed between the first contactor M/C and the power storages 21 and 22 to measure a current.

The current breaker FUSE is provided on a negative electrode side end of the battery 2 and cuts off the connection to the outside (the electric power supply circuit 11N) of the battery 2 when an abnormality occurs. In the power storage system 1 according to the present embodiment, the current breaker FUSE is implemented by a pyro-fuse which can intentionally cut off a current according to an electrical signal. When an abnormality (for example, vehicle collision or a short circuit in the battery 2) occurs, the current breaker FUSE is operated to cut off, and all the contactors and semiconductor switches in the battery 2 are turned off (opened).

In this way, when an abnormality occurs, the connection to the outside can be cut off at both the positive and negative ends of the battery 2. In both the first voltage state (800 V start-up) and the second voltage state (400 V start-up), reliable circuit cut-off can be performed by turning off the plurality of contactors and semiconductor switches on the circuit even when a failure occurs in the contactors and semiconductor switches. Further, since a pyro-fuse is used as the current breaker FUSE, it is not necessary to provide a contactor on the negative electrode side end of the battery 2, and thus the number of components and a cost can be reduced.

The three-phase motor 3 includes coils of three phases 32U, 32V, and 32W, one end side of each of which is connected to a neutral point 31, and is rotationally driven by electric power supplied from the battery 2 via the inverter 5. The three-phase motor 3 in the present embodiment includes a U-phase terminal 33U, a V-phase terminal 33V, and a W-phase terminal 33W connected to the other end side of each of the coils 32U, 32V, and 32W, respectively. The U-phase terminal 33U, the V-phase terminal 33V, and the W-phase terminal 33W are connected to the inverter 5. The other end side of a coil of any one phase among the coils 32U, 32V, 32W is connected to the branch circuit 14 at a connection portion 34. In the present embodiment, the coil 32U among the coils of three phases 32U, 32V, and 32W is connected to the branch circuit 14 at the connection portion 34 positioned between the U-phase terminal 33U and the inverter 5.

The inverter 5 converts DC electric power supplied from the battery 2 into three-phase AC electric power by switching of a plurality of switching elements, so as to rotationally drive the three-phase motor 3. When a DC (400 V) is supplied from the branch circuit 14 to the connection portion 34, the inverter 5 can function as a booster circuit to boost the DC (to 800 V) using the coil connected to the branch circuit 14 and the coil of another phase (in the present embodiment, the coils 32U and 32V or the coils 32U and 32W), by the switching of the plurality of switching elements. That is, the coils 32U, 32V, and 32W wound around a stator core are used as transformers. The inverter 5 allows a current to flow from the three-phase motor 3 side to the battery 2 side regardless of on and off states of a gate, and allows a current to flow from the battery 2 side to the three-phase motor 3 side only when the gate is in an on state.

The auxiliary device 4 is a high-voltage driven in-vehicle device which can be driven by DC electric power from the battery 2 and an external power supply, and examples thereof includes an electric compressor or a heater for air-conditioning. The auxiliary device 4 is connected to the battery 2 via the auxiliary device drive circuits 12P and 12N, a second contactor VS/C, and the electric power supply circuits 11P and 11N, which will be described later. The second contactor VS/C is an example of a third switch unit. The auxiliary device 4 according to the present embodiment operates at the base voltage of 800 V.

The DC-DC converter 6 steps down the DC electric power from the battery 2 and the external power supply to drive a low-voltage driven in-vehicle device. The DC-DC converter 6 is provided with an ammeter (not shown).

The electric power supply circuits 11P and 11N are configured as a positive and negative pair and connect the battery 2 and the inverter 5 (three-phase motor 3). The electric power supply circuits 11P and 11N are provided with connection portions 111P and 111N connected to the DC power supply circuits 13P and 13N and are provided with connection portions 112P and 112N connected to the auxiliary device drive circuits 12P and 12N (auxiliary device 4) on a side closer to the inverter 5 than the connection portions 111P and 111N. The electric power supply circuit 11P at the positive electrode side is provided with the second contactor VS/C which turns on and off the circuit between the connection portion 112P connected to the auxiliary device drive circuit 12P and the connection portion 111P connected to the DC power supply circuit 13P. A first voltage sensor V_PIN, the first smoothing capacitor C1 and a first resistor R1 are provided on the inverter 5 side of the electric power supply circuits 11P and 11N. The first voltage sensor V_PIN, the first smoothing capacitor C1, and the first resistor R1 are provided on a circuit that connects the electric power supply circuit 11P at the positive electrode side and the electric power supply circuit 11N at the negative electrode side. Note that the first resistor R1 is provided to discharge the first smoothing capacitor C1 when the circuit is cut off.

The DC power supply circuits 13P and 13N are configured as a positive and negative pair and include one end provided with charge terminals 131P and 131N to which an external power supply such as charging equipment can be connected and the other end connected to the electric power supply circuits 11P and 11N via the connection portions 111P and 111N. The DC power supply circuits 13P and 13N are provided with a third contactor QC/C_A and a fourth contactor QC/C_B for turning on and off the circuits, respectively. A second voltage sensor V_BAT is provided at a position closer to the connection portions 111P and 111N than the third contactor QC/C_A and the fourth contactor QC/C_B. A third voltage sensor V_QC is provided at a position closer to the charge terminals 131P and 131N than the third contactor QC/C_A and the fourth contactor QC/C_B.

The branch circuit 14 is branched, in the DC power supply circuit 13P at the positive electrode side, at a position closer to the connection portion 111P than the third contactor QC/C_A and the second voltage sensor V_BAT and is connected to one of the coils of the three-phase motor 3 via the connection portion 34. An intermediate portion of the branch circuit 14 is provided with a fifth contactor QC/C_C for turning on and off the circuit. The fifth contactor QC/C_C is an example of a second switch unit.

The control unit 10 is, for example, a vehicle ECU and controls driving and charging of the power storage system 1. More specifically, the control unit 10 performs ON/OFF control of each contactor M/C, VS/C, QC/C_A, QC/C_B, QC/C_C and failure detection (welding detection) thereof, ON/OFF control (including PWM control) of each semiconductor switch S/C_A, S/C_B, S/C_C and failure detection, and control of the DC-DC converter 6 and the inverter 5.

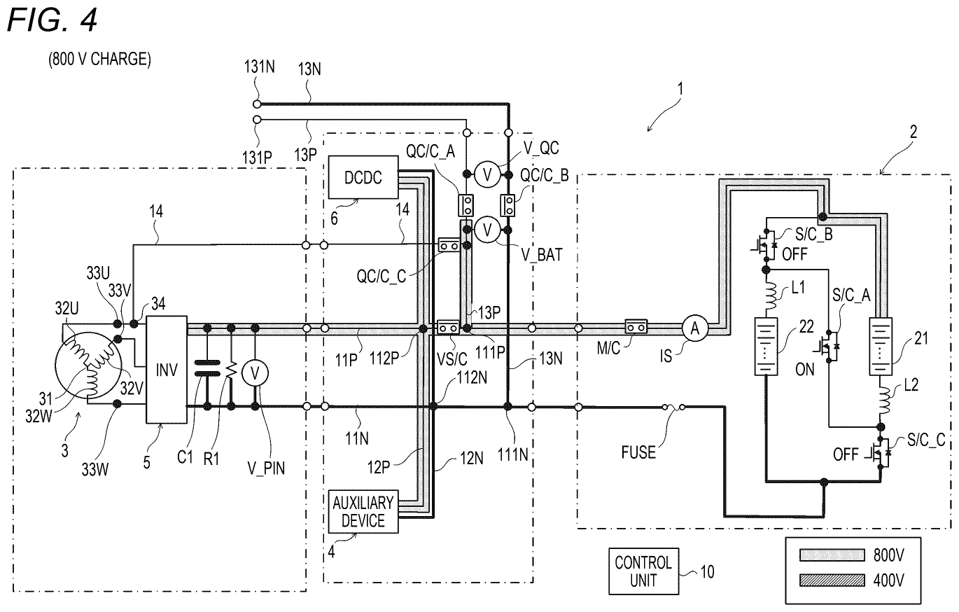

Next, an operation of the power storage system 1 will be described with reference to FIGS. 4 to 9.

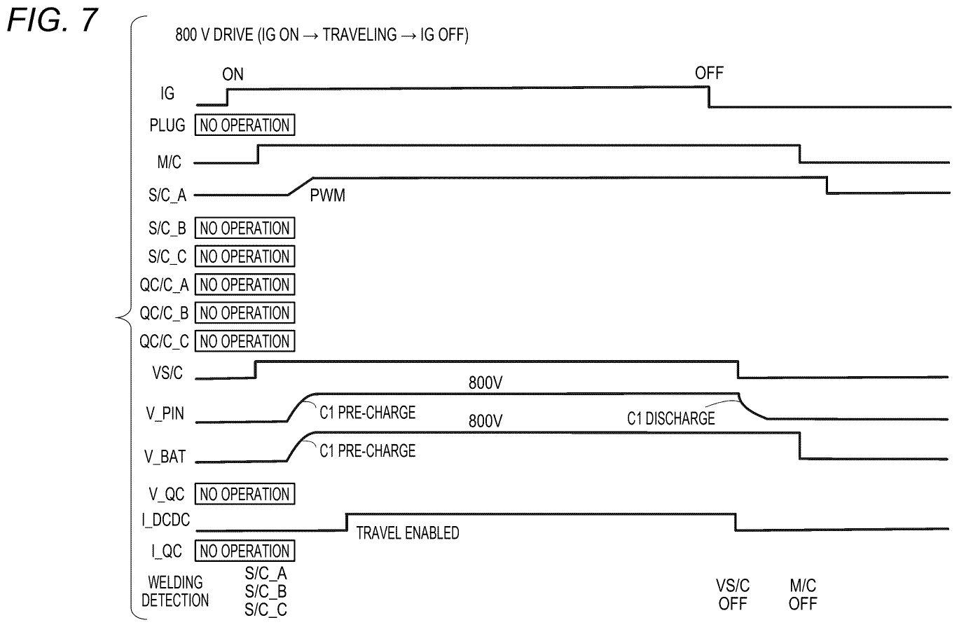

FIG. 4 is a diagram showing a flow of a current during traveling (800 V drive) of the electric vehicle including the power storage system 1 according to the first embodiment, and FIG. 7 is a diagram showing an operation sequence during traveling (800 V drive) of the electric vehicle including the power storage system 1 according to the first embodiment.

When an ignition switch IG of the electric vehicle is turned on, the control unit 10 first turns on the first contactor M/C and the second contactor VS/C and checks detected voltage values of the first voltage sensor V_PIN and the second voltage sensor V_BAT. When the detected voltage value of the first voltage sensor V_PIN or the second voltage sensor V_BAT increases, the control unit 10 determines that one of the first to third semiconductor switches S/C_A, S/C_B, and S/C_C fails and performs abnormality notification.

If it is determined that there is no failure in the first to third semiconductor switches S/C_A, S/C_B, and S/C_C, the control unit 10 switches the first semiconductor switch S/C_A to a continuous ON state after an intermittent ON period by PWM control, and connects the circuits in the battery 2 in the first voltage state (800 V). As a result, the first smoothing capacitor C1 is pre-charged, and the detected voltage values of the first voltage sensor V_PIN and the second voltage sensor V_BAT gradually increase. Then, when the pre-charging of the first smoothing capacitor C1 is completed, the electric vehicle becomes capable of traveling. In this case, the auxiliary device 4 is connected to the electric power supply circuits 11P and 11N via the auxiliary device drive circuits 12P and 12N and is driven by the first voltage (800 V) supplied from the battery 2.

On the other hand, when the ignition switch IG is turned off, the control unit 10 first turns off the second contactor VS/C and checks the detected voltage value of the first voltage sensor V_PIN. When the detected voltage value of the first voltage sensor V_PIN does not decrease due to discharging of the first smoothing capacitor C1, the control unit 10 determines that the second contactor VS/C fails and performs abnormality notification.

If it is determined that there is no failure in the second contactor VS/C, the control unit 10 turns off the first contactor M/C at a timing when the discharging of the first smoothing capacitor C1 is completed, and checks the detected voltage value of the second voltage sensor V_BAT. When the detected voltage value of the second voltage sensor V_BAT does not decrease, the control unit 10 determines that the first contactor M/C fails and performs abnormality notification.

If it is determined that there is no failure in the first contactor M/C, the control unit 10 turns off the first semiconductor switch S/C_A to end the operation sequence during traveling.

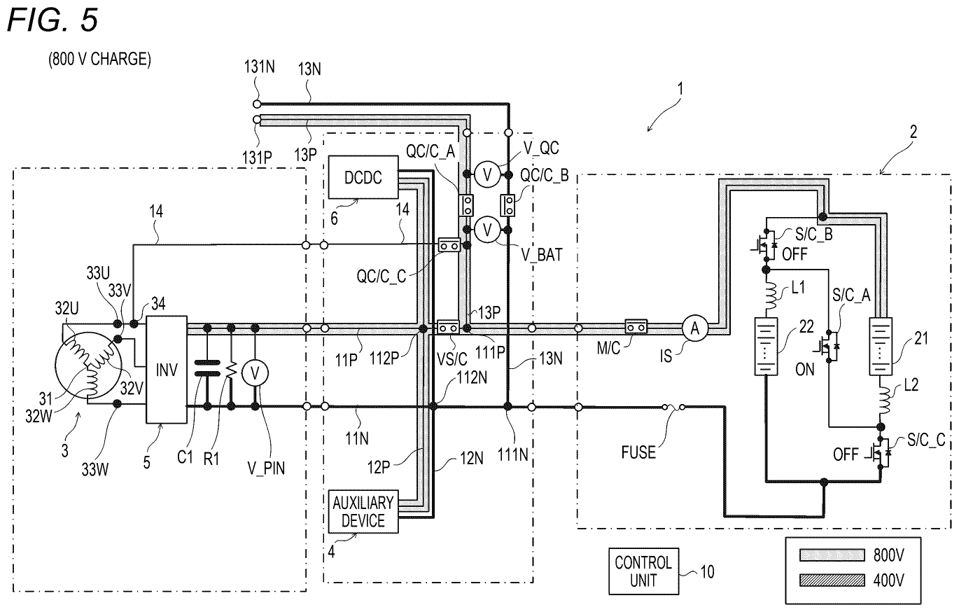

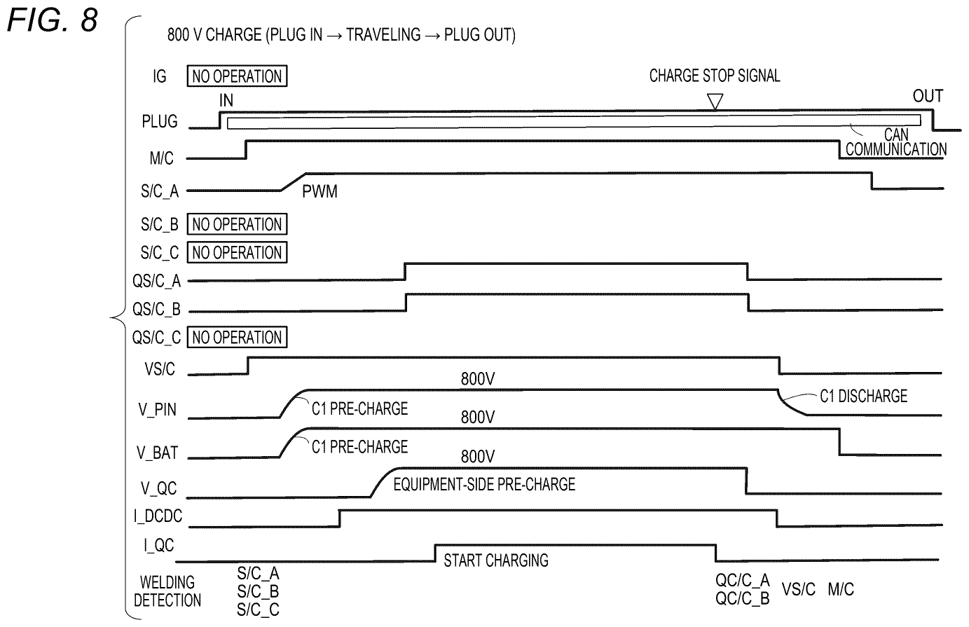

FIG. 5 is diagram showing a flow of a current during charging at the first voltage (800 V charge) of the electric vehicle including the power storage system 1 according to the first embodiment, and FIG. 8 is a diagram showing an operation sequence during charging at the first voltage (800 V charge) of the electric vehicle including the power storage system 1 according to the first embodiment.

When a charge plug is connected to the charge terminals 131P and 131N, the control unit 10 performs CAN communication with charging equipment to recognize a charge voltage. When the charge voltage is the first voltage (800 V), the control unit 10 first turns on the first contactor M/C and the second contactor VS/C and checks the detected voltage values of the first voltage sensor V_PIN and the second voltage sensor V_BAT. When the detected voltage value of the first voltage sensor V_PIN or the second voltage sensor V_BAT increases, the control unit 10 determines that one of the first to third semiconductor switches S/C_A, S/C_B, and S/C_C fails and performs abnormality notification.

If it is determined that there is no failure in the first to third semiconductor switches S/C_A, S/C_B, and S/C_C, the control unit 10 switches the first semiconductor switch S/C_A to a continuous ON state after an intermittent ON period by PWM control, and connects the circuits in the battery 2 in the first voltage state (800 V). As a result, the first smoothing capacitor C1 is pre-charged, and the detected voltage values of the first voltage sensor V_PIN and the second voltage sensor V_BAT gradually increase. Then, when the pre-charging of the first smoothing capacitor C1 is completed, the battery 2 enters a state in which charging at the first voltage (800 V) can start.

Thereafter, the control unit 10 turns on the third contactor QC/C_A and the fourth contactor QC/C_B to start charging the battery 2 at the first voltage (800 V). In this case, the auxiliary device 4 is connected to the DC power supply circuits 13P and 13N via the auxiliary device drive circuits 12P and 12N and the second contactor VS/C and is driven by the first voltage (800 V) supplied from the charging equipment.

On the other hand, when the control unit 10 determines that a charge stop signal is received, the control unit 10 turns off the third contactor QC/C_A and the fourth contactor QC/C_B and checks a detected voltage value of the third voltage sensor V_QC. When the detected voltage value of the third voltage sensor V_QC does not decrease, the control unit 10 determines that the third contactor QC/C_A and the fourth contactor QC/C_B fail and performs abnormality notification.

When the control unit 10 determines that there is no failure in the third contactor QC/C_A and the fourth contactor QC/C_B, the control unit 10 turns off the second contactor VS/C and checks the detected voltage value of the first voltage sensor V_PIN. When the detected voltage value of the first voltage sensor V_PIN does not decrease due to discharging of the first smoothing capacitor C1, the control unit 10 determines that the second contactor VS/C fails and performs abnormality notification.

If it is determined that there is no failure in the second contactor VS/C, the control unit 10 turns off the first contactor M/C at a timing when the discharging of the first smoothing capacitor C1 is completed, and checks the detected voltage value of the second voltage sensor V_BAT. When the detected voltage value of the second voltage sensor V_BAT does not decrease, the control unit 10 determines that the first contactor M/C fails and performs abnormality notification.

If it is determined that there is no failure in the first contactor M/C, the control unit 10 turns off the first semiconductor switch S/C_A to end the operation sequence during charging at the first voltage (800 V).

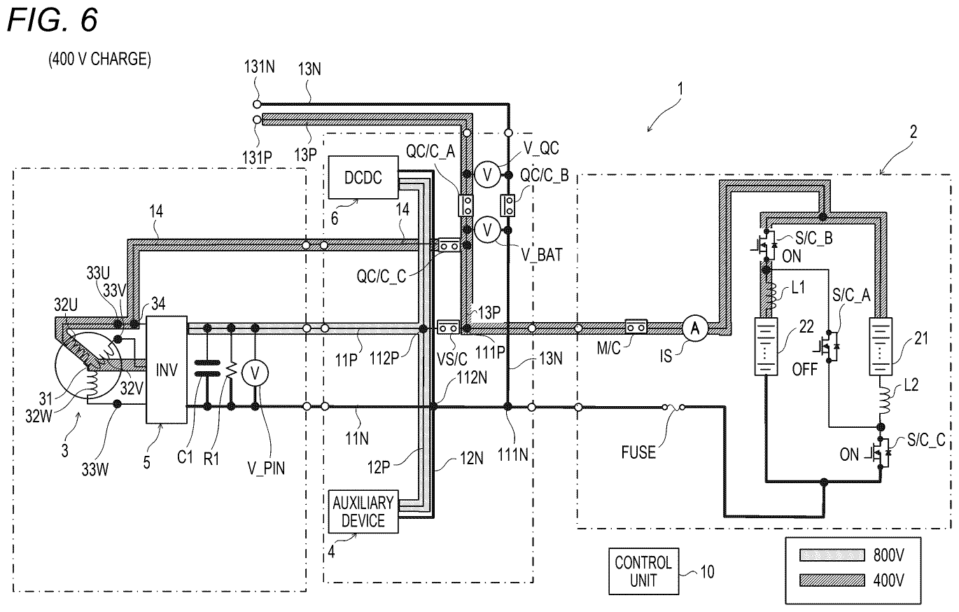

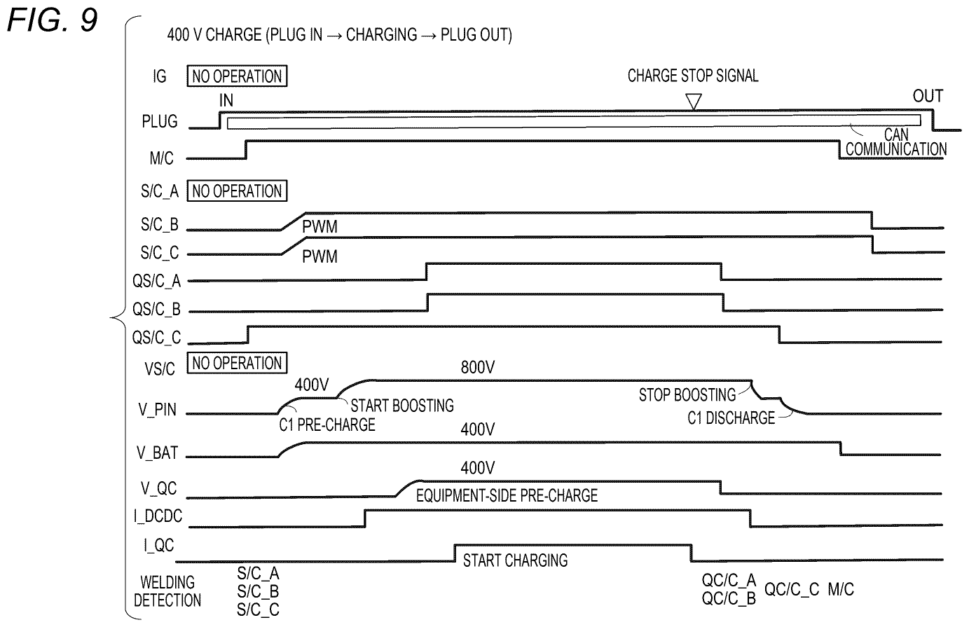

FIG. 6 is a diagram showing a flow of a current during charging at the second voltage (400 V charge) of the electric vehicle including the power storage system 1 according to the first embodiment, and FIG. 9 is a diagram showing an operation sequence during charging at the second voltage (400 V charge) of the electric vehicle including the power storage system 1 according to the first embodiment.

When a charge plug is connected to the charge terminals 131P and 131N, the control unit 10 performs CAN communication with charging equipment to recognize a charge voltage. When the charge voltage is the second voltage (400 V), the control unit 10 first turns on the first contactor M/C and the fifth contactor QC/C_C and checks the detected voltage values of the first voltage sensor V_PIN and the second voltage sensor V_BAT. When the detected voltage value of the first voltage sensor V_PIN or the second voltage sensor V_BAT increases, the control unit 10 determines that one of the first to third semiconductor switches S/C_A, S/C_B, and S/C_C fails and performs abnormality notification.

If it is determined that there is no failure in the first to third semiconductor switches S/C_A, S/C_B, and S/C_C, the control unit 10 switches the second semiconductor switch S/C_B and the third semiconductor switch S/C_C to the continuous ON state after the intermittent ON period by PWM control, and connects the circuits in the battery 2 in the second voltage state (400 V). As a result, the first smoothing capacitor C1 is pre-charged, and the detected voltage values of the first voltage sensor V_PIN and the second voltage sensor V_BAT gradually increase.

After enabling the booster circuit by the three-phase motor 3 and the inverter 5, the control unit 10 turns on the third contactor QC/C_A and the fourth contactor QC/C_B. Accordingly, the battery 2 enters a state in which charging at the second voltage (400 V) can be started. The three-phase motor 3 and the inverter 5 connected to the DC power supply circuits 13P and 13N via the branch circuit 14 boost the second voltage (400 V) supplied from the charging equipment to the first voltage (800 V) to drive the auxiliary device 4.

On the other hand, when the control unit 10 determines that a charge stop signal is received, the control unit 10 turns off the third contactor QC/C_A and the fourth contactor QC/C_B and checks a detected voltage value of the third voltage sensor V_QC. When the detected voltage value of the third voltage sensor V_QC does not decrease, the control unit 10 determines that the third contactor QC/C_A and the fourth contactor QC/C_B fail and performs abnormality notification.

When the control unit 10 determines that there is no failure in the third contactor QC/C_A and the fourth contactor QC/C_B, the control unit 10 stops the boosting performed by the three-phase motor 3 and the inverter 5, then turns off the fifth contactor QC/C_C and checks the detected voltage value of the first voltage sensor V_PIN. When the detected voltage value of the first voltage sensor V_PIN does not decrease, the control unit 10 determines that the fifth contactor QC/C_C fails and performs abnormality notification.

If it is determined that there is no failure in the fifth contactor QC/C_C, the control unit 10 turns off the first contactor M/C and checks the detected voltage value of the second voltage sensor V_BAT. When the detected voltage value of the second voltage sensor V_BAT does not decrease, the control unit 10 determines that the first contactor M/C fails and performs abnormality notification.

If it is determined that there is no failure in the first contactor M/C, the control unit 10 turns off the second semiconductor switch S/C_B and the third semiconductor switch S/C_C to end the operation sequence during charging at the second voltage (400 V).

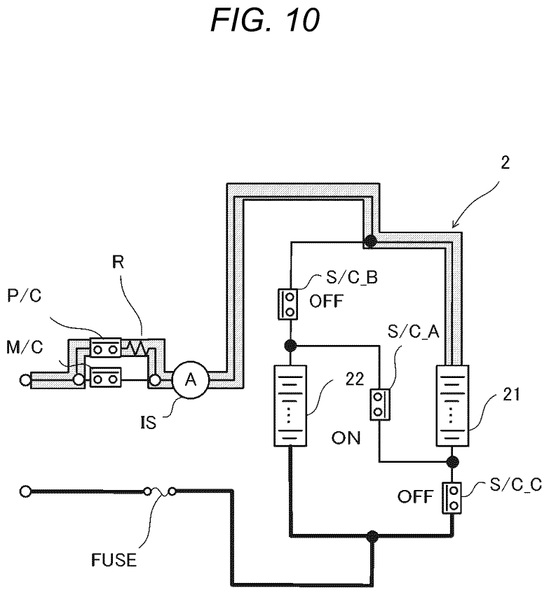

Next, the pre-charge operation will be described with reference to FIGS. 10 to 13.

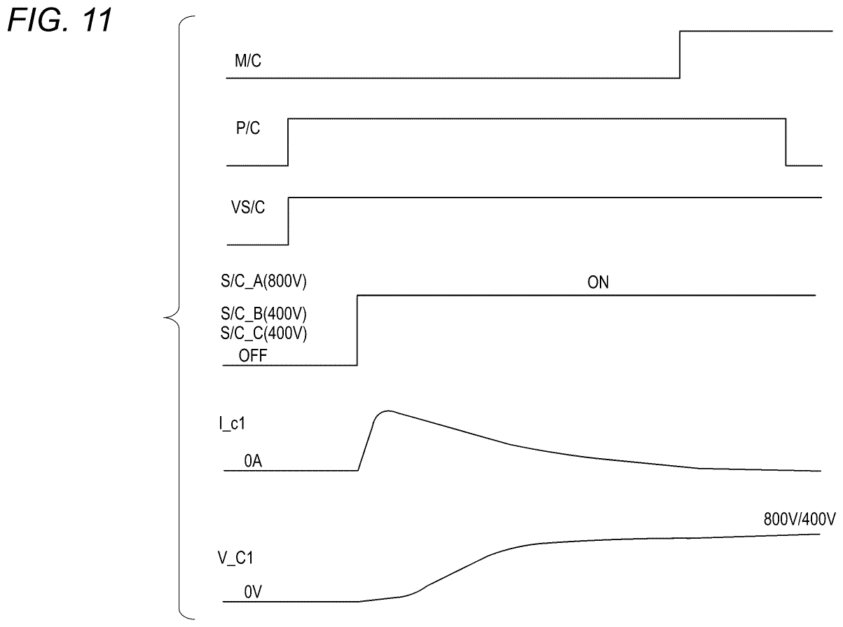

FIG. 10 is a diagram showing the first voltage state (800 V start-up) of the battery 2 according to a comparative example, and FIG. 11 is a diagram showing an operation sequence during a pre-charge operation according to the comparative example.

As in the comparative example shown in FIG. 10, when the first switch unit (S/C_A, S/C_B, S/C_C) that switches between the first voltage state (800 V start-up) and the second voltage state (400 V start-up) is implemented by a mechanical switch (such as a contactor) which is not capable of high frequency switching, a pre-charge circuit is provided to pre-charge the first smoothing capacitor C1. The pre-charge circuit is provided, for example, in parallel with the first contactor M/C. In the pre-charge circuit, a pre-charge contactor P/C and a pre-charge resistor R are arranged in series.

As shown in FIG. 11, when the control unit 10 starts up the battery 2 in the first voltage state (800 V start-up), the control unit 10 turns on the pre-charge contactor P/C and the second contactor VS/C (see FIG. 1) before the first contactor M/C, and then turns on the mechanical switch S/C_A (in the case of the second voltage state, the mechanical switch S/C_B and the mechanical switch S/C_C). As a result, a current (I_C1) determined by the pre-charge resistor R flows through the first smoothing capacitor C1, and the first smoothing capacitor C1 is pre-charged (V_C1).

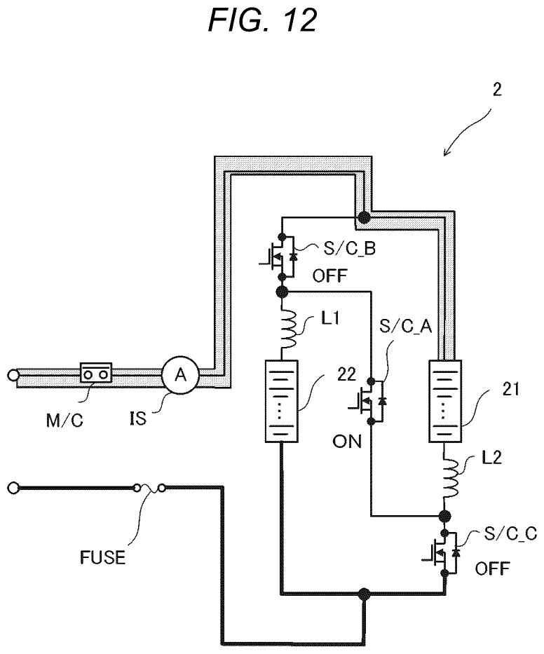

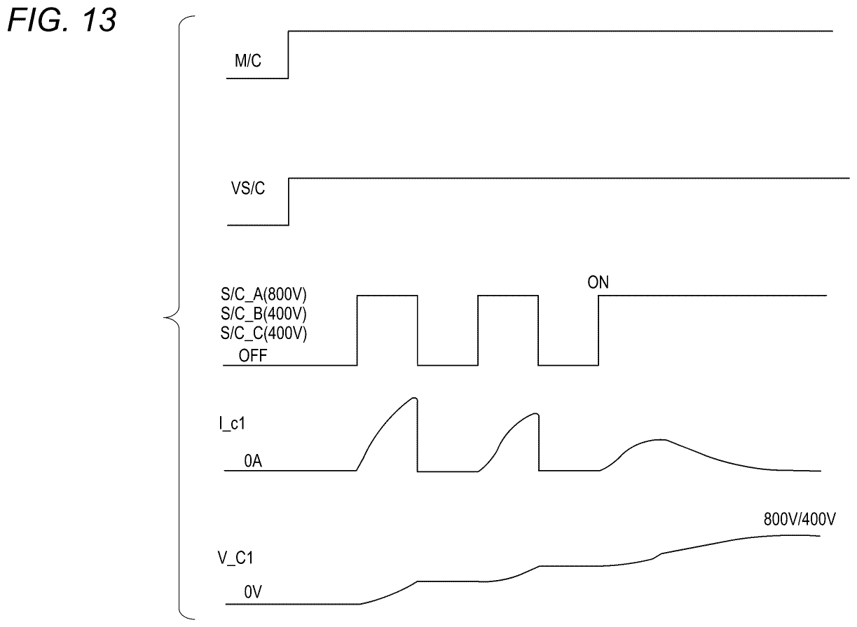

FIG. 12 is a diagram showing the first voltage state (800 V start-up) of the battery 2 according to the first embodiment, and FIG. 13 is a diagram showing an operation sequence during a pre-charge operation according to the first embodiment.

As shown in FIG. 12, in the present embodiment, the first switch unit is implemented by the semiconductor switches S/C_A, S/C_B, and S/C_C. As shown in FIG. 13, when the control unit 10 starts up the battery 2 in the first voltage state (800 V start-up), the control unit 10 turns on the first contactor M/C and the second contactor VS/C (see FIG. 1) and then turns on the first semiconductor switch S/C_A (in the case of the second voltage state, the second semiconductor switch S/C_B and the third semiconductor switch S/C_C). In this case, the control unit 10 controls the current flowing through the first smoothing capacitor C1 by intermittently turning on the first semiconductor switch S/C_A by PWM control, thereby pre-charging the first smoothing capacitor C1.

A gradient of the current value I_C1 flowing through the first smoothing capacitor C1 is determined by inductances of the reactors L1 and L2. If an initial ON time of the first semiconductor switch S/C_A (or the second semiconductor switch S/C_B and the third semiconductor switch S/C_C) is long, there is a possibility that the reactors L1 and L2 will saturate and a short circuit current will occur, and therefore, the control unit 10 determines an upper limit current that will not saturate and switches the first semiconductor switch S/C_A (or the second semiconductor switch S/C_B and the third semiconductor switch S/C_C). In this way, by implementing the first switch unit with the semiconductor switches S/C_A, S/C_B, and S/C_C and performing PWM control on the first switch unit to pre-charge the first smoothing capacitor C1, the pre-charge circuit in FIG. 10 can be omitted.

### Second Embodiment

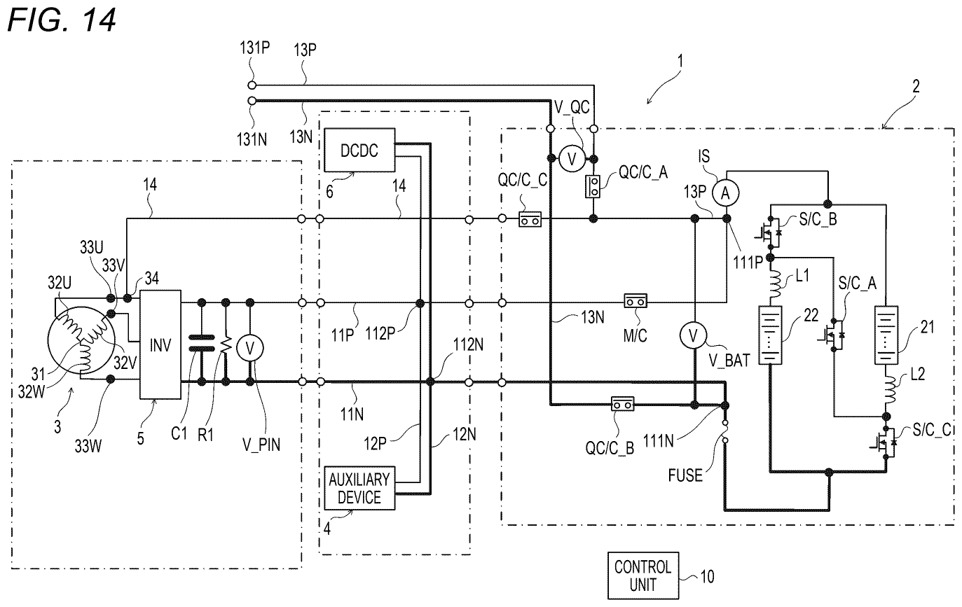

Next, the power storage system 1 according to the second embodiment will be described with reference to FIGS. 14 to 20. Here, the same reference numerals as in the first embodiment are used for the same configurations as in the first embodiment, and the description of the first embodiment may be incorporated.

In the power storage system 1 according to the first embodiment, the third contactor QC/C_A which is a main switch for charging is connected in series to the first contactor M/C which is the main switch of the battery 2. However, in the power storage system 1 according to the second embodiment, the third contactor QC/C_A is connected in parallel to the first contactor M/C as shown in FIG. 14.

In the power storage system 1 according to the second embodiment, the same effect as those of the power storage system 1 according to the first embodiment can be obtained based on an operation according to an operation sequence to be described later. In the power storage system 1 according to the second embodiment, during charging with the second voltage (400 V), the battery 2 charged with the second voltage (400 V) can be separated, by the first contactor M/C, from the first voltage (800 V) boosted by the three-phase motor 3 and the inverter 5, and thus no switch component corresponding to the second contactor VS/C of the first embodiment is required.

The second embodiment is similar to the first embodiment in that the first to third semiconductor switches S/C_A, S/C_B, and S/C_C constitute an example of the first switch unit and the fifth contactor QC/C_C is an example of the second switch unit, and is different from the first embodiment in that the first contactor M/C is an example of the third switch unit.

In the power storage system 1 according to the second embodiment, the third contactor QC/C_A, the fourth contactor QC/C_B, the fifth contactor QC/C_C, the second voltage sensor V_BAT, and the third voltage sensor V_QC are arranged in the battery 2.

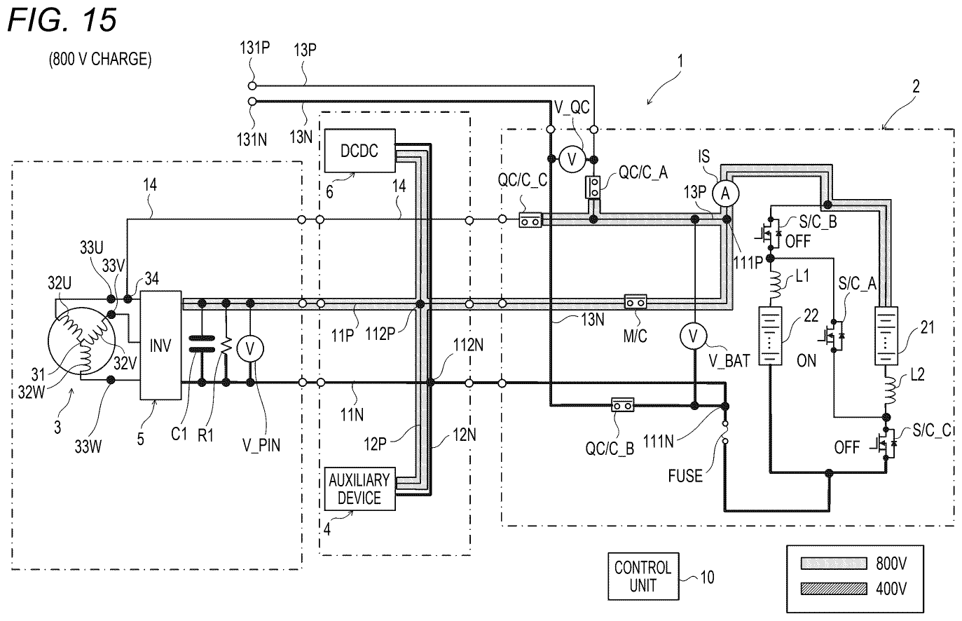

Next, an operation of the power storage system 1 according to the second embodiment will be described with reference to FIGS. 15 to 20.

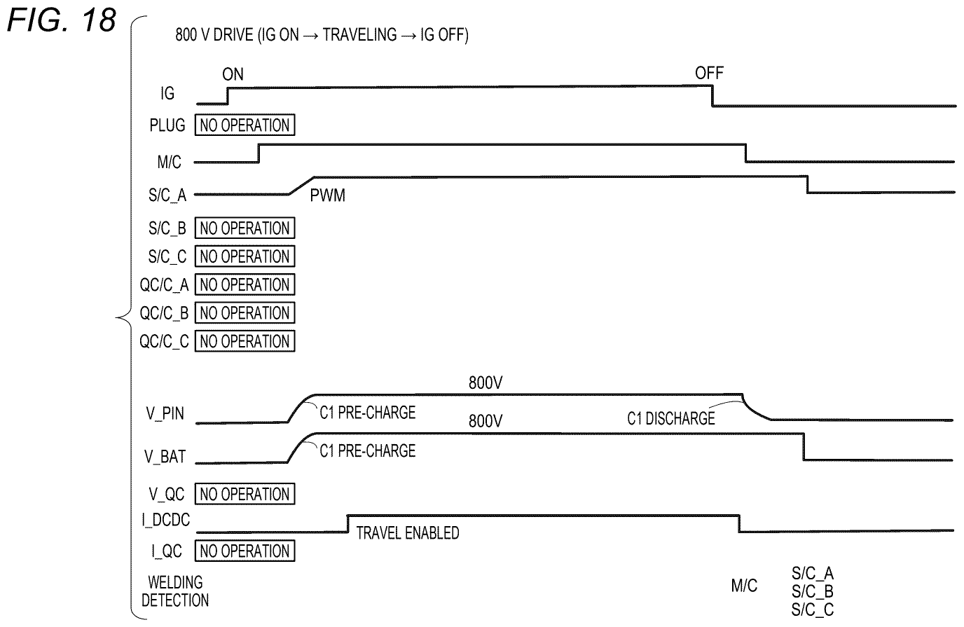

FIG. 15 is a diagram showing a flow of a current during traveling (800 V drive) of the electric vehicle including the power storage system 1 according to the second embodiment, and FIG. 18 is a diagram showing an operation sequence during traveling (800 V drive) of the electric vehicle including the power storage system 1 according to the second embodiment.

When the ignition switch IG of the electric vehicle is turned on, the control unit 10 turns on the first contactor M/C, and then switches the first semiconductor switch S/C_A to the continuous ON state after the intermittent ON period by the PWM control, and connects the circuits in the battery 2 in the first voltage state (800 V). As a result, the first smoothing capacitor C1 is pre-charged, and the detected voltage values of the first voltage sensor V_PIN and the second voltage sensor V_BAT gradually increase. Then, when the pre-charging of the first smoothing capacitor C1 is completed, the electric vehicle becomes capable of traveling. In this case, the auxiliary device 4 is connected to the electric power supply circuits 11P and 11N via the auxiliary device drive circuits 12P and 12N and is driven by the first voltage (800 V) supplied from the battery 2.

On the other hand, when the ignition switch IG is turned off, the control unit 10 first turns off the first contactor M/C and checks the detected voltage value of the first voltage sensor V_PIN. When the detected voltage value of the first voltage sensor V_PIN does not decrease due to discharging of the first smoothing capacitor C1, the control unit 10 determines that the first contactor M/C fails and performs abnormality notification.

If it is determined that there is no failure in the first contactor M/C, the control unit 10 turns off the first semiconductor switch S/C_A at a timing when the discharging of the first smoothing capacitor C1 is completed, and checks the detected voltage value of the second voltage sensor V_BAT. When the detected voltage value of the second voltage sensor V_BAT does not decrease, the control unit 10 determines that one of the first to third semiconductor switches S/C_A, S/C_B, and S/C_C fails and performs abnormality notification.

If it is determined that there is no failure in the first to third semiconductor switches S/C_A, S/C_B, and S/C_C, the control unit 10 ends the operation sequence during traveling.

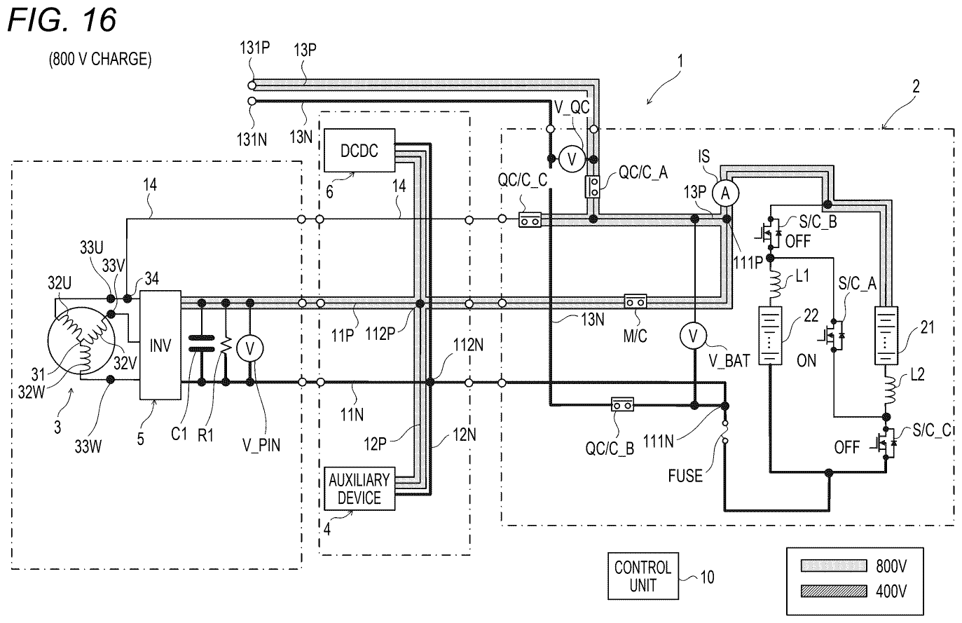

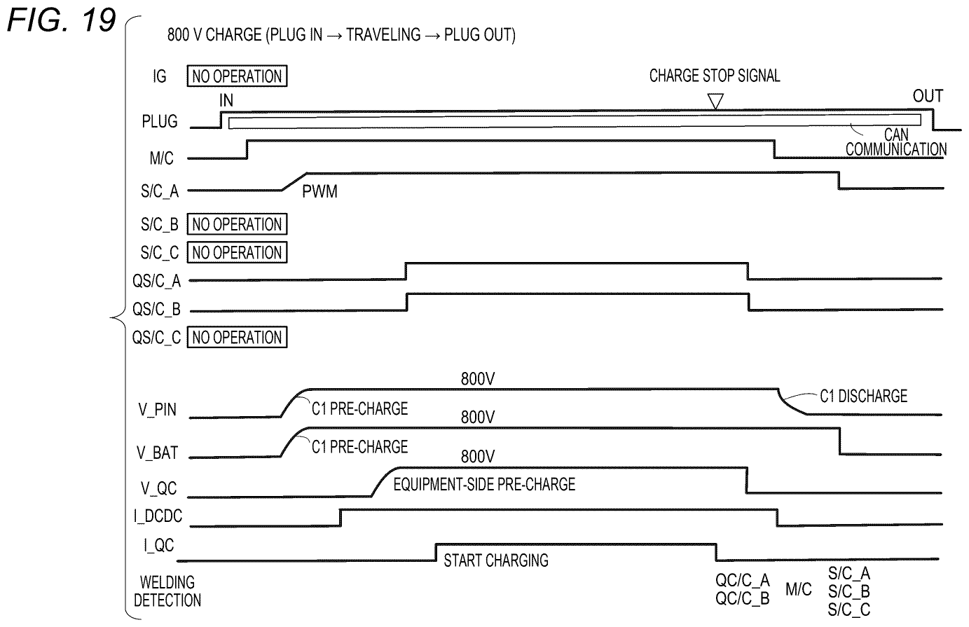

FIG. 16 is diagram showing a flow of a current during charging at the first voltage (800 V charge) of the electric vehicle including the power storage system 1 according to the second embodiment, and FIG. 19 is a diagram showing an operation sequence during charging at the first voltage (800 V charge) of the electric vehicle including the power storage system 1 according to the second embodiment.

When a charge plug is connected to the charge terminals 131P and 131N, the control unit 10 performs CAN communication with charging equipment to recognize a charge voltage. When the charge voltage is the first voltage (800 V), the control unit 10 turns on the first contactor M/C, and then switches the first semiconductor switch S/C_A to the continuous ON state after the intermittent ON period by the PWM control, and connects the circuits in the battery 2 in the first voltage state (800 V). As a result, the first smoothing capacitor C1 is pre-charged, and the detected voltage values of the first voltage sensor V_PIN and the second voltage sensor V_BAT gradually increase. Then, when the pre-charging of the first smoothing capacitor C1 is completed, the battery 2 enters a state in which charging at the first voltage (800 V) can start.

Thereafter, the control unit 10 turns on the third contactor QC/C_A and the fourth contactor QC/C_B to start charging the battery 2 at the first voltage (800 V). In this case, the auxiliary device 4 is connected to the DC power supply circuits 13P and 13N via the auxiliary device drive circuits 12P and 12N and the first contactor M/C and is driven by the first voltage (800 V) supplied from the charging equipment.

On the other hand, when the control unit 10 determines that a charge stop signal is received, the control unit 10 turns off the third contactor QC/C_A and the fourth contactor QC/C_B and checks a detected voltage value of the third voltage sensor V_QC. When the detected voltage value of the third voltage sensor V_QC does not decrease, the control unit 10 determines that the third contactor QC/C_A and the fourth contactor QC/C_B fail and performs abnormality notification.

When the control unit 10 determines that there is no failure in the third contactor QC/C_A and the fourth contactor QC/C_B, the control unit 10 turns off the first contactor M/C and checks the detected voltage value of the first voltage sensor V_PIN. When the detected voltage value of the first voltage sensor V_PIN does not decrease due to discharging of the first smoothing capacitor C1, the control unit 10 determines that the first contactor M/C fails and performs abnormality notification.

If it is determined that there is no failure in the first contactor M/C, the control unit 10 turns off the first semiconductor switch S/C_A at a timing when the discharging of the first smoothing capacitor C1 is completed, and checks the detected voltage value of the second voltage sensor V_BAT. When the detected voltage value of the second voltage sensor V_BAT does not decrease, the control unit 10 determines that one of the first to third semiconductor switches S/C_A, S/C_B, and S/C_C fails and performs abnormality notification.

If it is determined that there is no failure in the first to third semiconductor switches S/C_A, S/C_B, and S/C_C, the control unit 10 ends the operation sequence during charging at the first voltage (800 V).

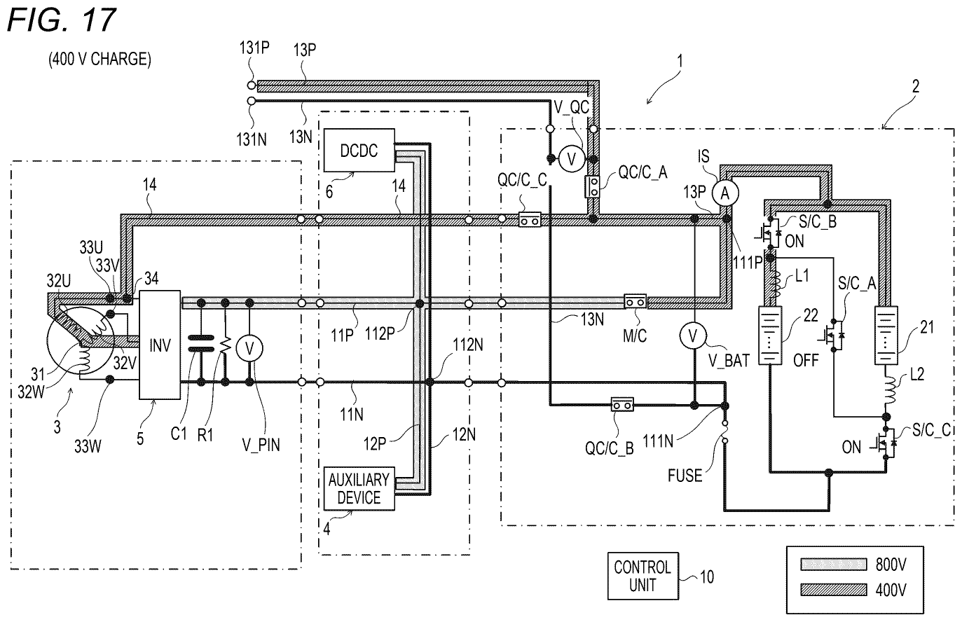

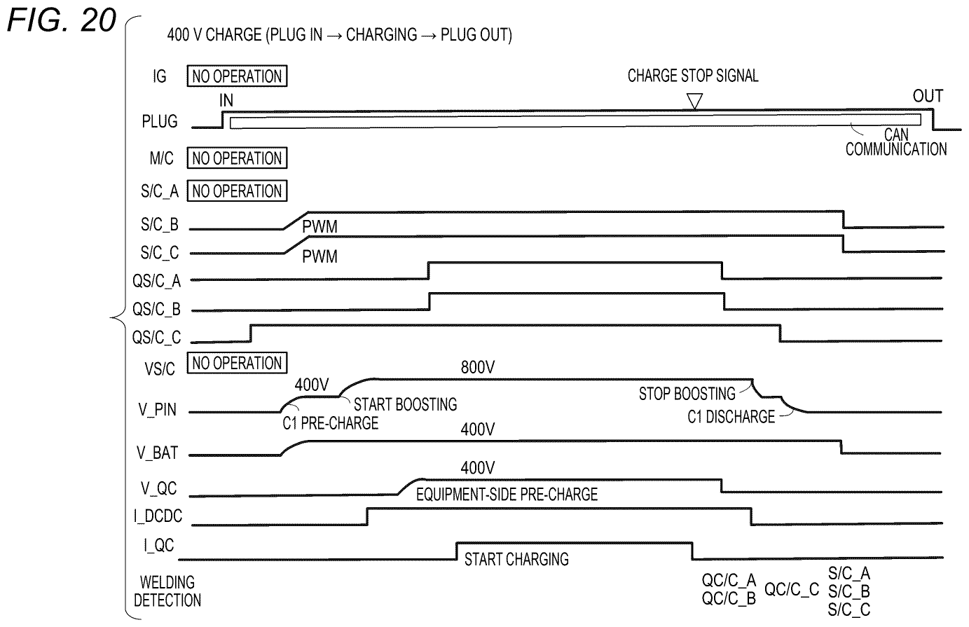

FIG. 17 is a diagram showing a flow of a current during charging at the second voltage (400 V charge) of the electric vehicle including the power storage system 1 according to the second embodiment, and FIG. 20 is a diagram showing an operation sequence during charging at the second voltage (400 V charge) of the electric vehicle including the power storage system 1 according to the second embodiment.

When a charge plug is connected to the charge terminals 131P and 131N, the control unit 10 performs CAN communication with charging equipment to recognize a charge voltage. When the charge voltage is the second voltage (400 V), the control unit 10 turns on the fifth contactor QC/C_C, and then switches the second semiconductor switch S/C_B and the third semiconductor switch S/C_C to the continuous ON state after the intermittent ON period by the PWM control, and connects the circuits in the battery 2 in the second voltage state (400 V). As a result, the first smoothing capacitor C1 is pre-charged, and the detected voltage values of the first voltage sensor V_PIN and the second voltage sensor V_BAT gradually increase.

After enabling the booster circuit by the three-phase motor 3 and the inverter 5, the control unit 10 turns on the third contactor QC/C_A and the fourth contactor QC/C_B. Accordingly, the battery 2 enters a state in which charging at the second voltage (400 V) can be started. The three-phase motor 3 and the inverter 5 connected to the DC power supply circuits 13P and 13N via the branch circuit 14 boost the second voltage (400 V) supplied from the charging equipment to the first voltage (800 V) to drive the auxiliary device 4.

On the other hand, when the control unit 10 determines that a charge stop signal is received, the control unit 10 turns off the third contactor QC/C_A and the fourth contactor QC/C_B and checks a detected voltage value of the third voltage sensor V_QC. When the detected voltage value of the third voltage sensor V_QC does not decrease, the control unit 10 determines that the third contactor QC/C_A and the fourth contactor QC/C_B fail and performs abnormality notification.

When the control unit 10 determines that there is no failure in the third contactor QC/C_A and the fourth contactor QC/C_B, the control unit 10 stops the boosting performed by the three-phase motor 3 and the inverter 5, then turns off the fifth contactor QC/C_C and checks the detected voltage value of the first voltage sensor V_PIN. When the detected voltage value of the first voltage sensor V_PIN does not decrease, the control unit 10 determines that the fifth contactor QC/C_C fails and performs abnormality notification.

If it is determined that there is no failure in the fifth contactor QC/C_C, the control unit 10 turns off the second semiconductor switch S/C_B and the third semiconductor switch S/C_C, and checks the detected voltage value of the second voltage sensor V_BAT. When the detected voltage value of the second voltage sensor V_BAT does not decrease, the control unit 10 determines that one of the first to third semiconductor switches S/C_A, S/C_B, and S/C_C fails and performs abnormality notification.

If it is determined that there is no failure in the first to third semiconductor switches S/C_A, S/C_B, and S/C_C, the control unit 10 ends the operation sequence during charging at the second voltage (400 V).

Next, a modification of the power storage system 1 according to the first embodiment will be described. Note that the same reference numerals as in the first embodiment are used for the same configurations as in the first embodiment, and description thereof will be omitted, and only changes will be described.

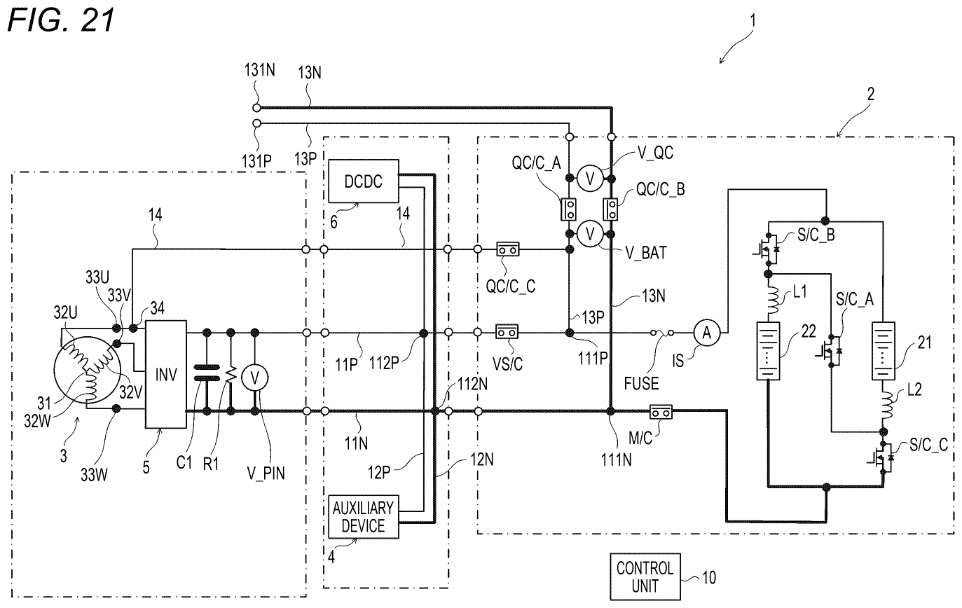

FIG. 21 is a diagram showing a configuration of the modification of the power storage system 1 according to the first embodiment.

In the power storage system 1 according to the first embodiment shown in FIG. 1, the first contactor M/C is provided on the positive electrode side end of the battery 2, and the current breaker FUSE is provided on the negative electrode side end of the battery 2. However, in the present modification, as shown in FIG. 21, the first contactor M/C is provided on the negative electrode side of the battery 2, and the current breaker FUSE is provided on the positive electrode side of the battery 2. Furthermore, as a configuration of the battery 2, the second contactor VS/C, the third contactor QC/C_A, the fourth contactor QC/C_B, the fifth contactor QC/C_C, the third voltage sensor V_QC, and the second voltage sensor V_BAT are provided closer to the end sides than the first contactor M/C and the current breaker FUSE.

In the power storage system 1 according to the first embodiment shown in FIG. 1, when the power of the battery 2 is cut off such as when the battery 2 fails, in other words, when the electric power supply to the outside of the battery 2 is cut off, it is necessary to turn off the first contactor M/C provided on the positive electrode side end of the battery 2 and to cut off the current breaker FUSE provided on the negative electrode side end of the battery 2. Once the current breaker FUSE is cut, replacement is necessary.

In the present modification, when cutting off the power of the battery 2, the second contactor VS/C and the third contactor QC/C_A, which are provided on the positive electrode side of the battery 2 and closer to the end side than the current breaker FUSE, are turned off, and the first contactor M/C provided on the negative electrode side of the battery 2 is turned off, so that the power of the battery 2 can be cut off without cutting off the current breaker FUSE. In this way, according to the present modification, the power of the battery 2 can be cut off only by ON/OFF control of the contactors, and therefore, control can be simplified and replacement of the current breaker FUSE can be made unnecessary.

Although the various embodiments have been described above with reference to the drawings, it is needless to say that the present disclosure is not limited to these examples. It is apparent to those skilled in the art that various changes and modifications can be conceived within the scope of the claims, and it is understood that such modifications and changes naturally fall within the technical scope of the present disclosure. In addition, respective constituent elements in the above-described embodiments may be freely combined without departing from the gist of the disclosure.

For example, in the above embodiments, the control unit 10 performs CAN communication with the charging equipment, but the communication method is not limited to CAN communication, and any communication method can be adopted.

In the present specification, at least the following matters are described. Although corresponding constituent elements or the like in the above-described embodiments are shown in parentheses, the present disclosure is not limited thereto.
(1) A power storage system, including:
a battery (battery 2) including a first power storage (first power storage 21), a second power storage (second power storage 22), and a first switch unit configured to switch between a first voltage state in which the first power storage and the second power storage are connected in series and chargeable at a first voltage, and a second voltage state in which the first power storage and the second power storage are connected in parallel and chargeable at a second voltage;
a three-phase motor (three-phase motor 3) in which coils of three phases (coils 32U, 32V, and 32W) are connected at a neutral point (neutral point 31), the three-phase motor being driven by electric power supplied from the battery;
an inverter (inverter 5) connected on an electric power transmission path (electric power supply circuits 11P and 11N) between the battery and the three-phase motor;
a DC power supply circuit (DC power supply circuits 13P and 13N) connected to a first connection portion (connection portions 111P and 111N) positioned on an electric power transmission path between the inverter and the battery;
a capacitor (first smoothing capacitor C1) provided on the electric power transmission path between the battery and the three-phase motor; and
a branch circuit (branch circuit 14) that branches off from the DC power supply circuit on a positive electrode side and is connected to a coil of any one phase among the coils of three phases, in which
the first switch unit includes a semiconductor switch (first semiconductor switch S/C_A, second semiconductor switch S/C_B, and third semiconductor switch S/C_C).

According to (1), it is possible to appropriately perform charging according to a voltage state of charging equipment by switching, by the first switch unit, a mode of connection between the first power storage and the second power storage both in a system in which the external charging equipment performs charging at the first voltage or a system in which the external charging equipment performs charging at the second voltage. That is, charging can be performed without passing through any voltage converter during charging, efficiency deterioration due to a voltage converter can be avoided, and it is possible to eliminate a voltage converter for charging.

Since the DC power supply circuit on the positive electrode side connected to the connection portion positioned on the electric power transmission path between the inverter and the battery includes the branch circuit connected to a coil of any one phase among the three-phase motor, voltage conversion can be performed using the three-phase motor and the inverter. Accordingly, even when the voltage state of the charging equipment is different from an operating voltage of an auxiliary device or the like, it is not necessary to provide a dedicated voltage converter, and thus a manufacturing cost can be reduced.

By configuring the first switch unit to include a semiconductor switch, a pre-charge circuit is not required, and volume and weight of the circuits in the battery can be reduced, as compared with a configuration including a contactor.
(2) The power storage system according to (1), further including:
a control unit (control unit 10) configured to control the first switch unit, in which
the control unit performs PWM control on the first switch unit during pre-charge of the capacitor.

According to (2), the capacitor can be pre-charged by performing PWM control on the semiconductor switch.
(3) The power storage system according to (1) or (2), in which
the battery includes
   a positive electrode side path (positive electrode side path K1) of the first power storage,
   a positive electrode side path (positive electrode side path K2) of the second power storage,
   a positive electrode side node (positive electrode side node N1) at which the positive electrode side path of the first power storage and the positive electrode side path of the second power storage are connected in parallel,
   a negative electrode side path (negative electrode side path K3) of the first power storage,
   a negative electrode side path (negative electrode side path K4) of the second power storage,
   a negative electrode side node (negative electrode side node N2) at which the negative electrode side path of the first power storage and the negative electrode side path of the second power storage are connected in parallel,
   a series connection path (series connection path K5) connecting the negative electrode side path of the first power storage and the positive electrode side path of the second power storage,
   a negative electrode side connection node (negative electrode side connection node N3) at which the series connection path and the negative electrode side path of the first power storage are connected, and
   a positive electrode side connection node (positive electrode side connection node N4) at which the series connection path and the positive electrode side path of the second power storage are connected, and
the first switch unit includes
   a first semiconductor switch (first semiconductor switch S/C_A) disposed in the series connection path,
   a second semiconductor switch (second semiconductor switch S/C_B) disposed between the positive electrode side node and the positive electrode side connection node,
   a third semiconductor switch (third semiconductor switch S/C_C) disposed between the negative electrode side node and the negative electrode side connection node,
   a first reactor (first reactor L1) disposed between the positive electrode side connection node and a positive electrode of the second power storage, and
   a second reactor (second reactor L2) disposed between the negative electrode side connection node and a negative electrode of the first power storage.

According to (3), when starting up at the first voltage, the two reactors are connected in series, and when starting up at the second voltage, the reactors are connected to the paths respectively, with the reactors being appropriately positioned depending on the voltage.
(4) The power storage system according to (1) or (2), in which
the branch circuit is connected to a coil of any one phase among the coils of three phases at a second connection portion (connection portion 34) via a second switch unit (fifth contactor QC/C_C).

According to (4), when the three-phase motor does not perform voltage conversion, that is, when the coils of the three-phase motor are not used as transformers, a connection to the second connection portion can be cut off.
(5) The power storage system according to (1) or (2), further including:
an auxiliary device (auxiliary device 4) configured to be driven by DC electric power from the battery and an external power supply; and
an auxiliary device drive circuit (auxiliary device drive circuits 12P and 12N) connected on an electric power transmission path between the inverter and the first connection portion, and configured to supply electric power to the auxiliary device, in which
the auxiliary device is operated at the first voltage.

According to (5), it is unnecessary to perform voltage conversion during traveling and during charging at the first voltage.
(6) The power storage system according to (5), in which
the auxiliary device is connected to the battery via a third switch unit (second contactor VS/C according to the first embodiment, the first contactor M/C according to the second embodiment).

According to (6), when voltage conversion is performed by the three-phase motor, that is, when the coils of the three-phase motor are used as transformers, the third switch unit can separate a portion in the first voltage state from a portion in the second voltage state.
(7) The power storage system according to (1) or (2), further including:
a control unit (control unit 10) configured to control the first switch unit and the inverter, in which
when the battery is charged at the second voltage, the control unit causes the inverter to boost a voltage supplied from the branch circuit to the three-phase motor to the first voltage.

According to (7), since voltage conversion can be performed using the three-phase motor and the inverter, it is possible to eliminate an auxiliary device voltage converter.

1. A power storage system, comprising:
a battery including a first power storage, a second power storage, and a first switch unit configured to switch between a first voltage state in which the first power storage and the second power storage are connected in series and chargeable at a first voltage, and a second voltage state in which the first power storage and the second power storage are connected in parallel and chargeable at a second voltage;
a three-phase motor in which coils of three phases are connected at a neutral point, the three-phase motor being driven by electric power supplied from the battery;
an inverter connected on an electric power transmission path between the battery and the three-phase motor;
a DC power supply circuit connected to a first connection portion positioned on an electric power transmission path between the inverter and the battery;
a capacitor provided on the electric power transmission path between the battery and the three-phase motor; and
a branch circuit that branches off from the DC power supply circuit on a positive electrode side and is connected to a coil of any one phase among the coils of three phases, wherein
the first switch unit includes a semiconductor switch.

2. The power storage system according to claim 1, further comprising:
a control unit configured to control the first switch unit, wherein
the control unit performs PWM control on the first switch unit during pre-charge of the capacitor.

3. The power storage system according to claim 1, wherein
the battery includes
a positive electrode side path of the first power storage,
a positive electrode side path of the second power storage,
a positive electrode side node at which the positive electrode side path of the first power storage and the positive electrode side path of the second power storage are connected in parallel,
a negative electrode side path of the first power storage,
a negative electrode side path of the second power storage,
a negative electrode side node at which the negative electrode side path of the first power storage and the negative electrode side path of the second power storage are connected in parallel,
a series connection path connecting the negative electrode side path of the first power storage and the positive electrode side path of the second power storage,
a negative electrode side connection node at which the series connection path and the negative electrode side path of the first power storage are connected, and
a positive electrode side connection node at which the series connection path and the positive electrode side path of the second power storage are connected, and
the first switch unit includes
a first semiconductor switch disposed in the series connection path,
a second semiconductor switch disposed between the positive electrode side node and the positive electrode side connection node,
a third semiconductor switch disposed between the negative electrode side node and the negative electrode side connection node,
a first reactor disposed between the positive electrode side connection node and a positive electrode of the second power storage, and
a second reactor disposed between the negative electrode side connection node and a negative electrode of the first power storage.

4. The power storage system according to claim 1, wherein
the branch circuit is connected to a coil of any one phase among the coils of three phases at a second connection portion via a second switch unit.

5. The power storage system according to claim 1, further comprising:
an auxiliary device configured to be driven by DC electric power from the battery and an external power supply; and
an auxiliary device drive circuit connected on an electric power transmission path between the inverter and the first connection portion, and configured to supply electric power to the auxiliary device, wherein
the auxiliary device is operated at the first voltage.

6. The power storage system according to claim 5, wherein
the auxiliary device is connected to the battery via a third switch unit.

7. The power storage system according to claim 1, further comprising:
a control unit configured to control the first switch unit and the inverter, wherein
when the battery is charged at the second voltage, the control unit causes the inverter to boost a voltage supplied from the branch circuit to the three-phase motor to the first voltage.
